(19) United States
(12) Patent Application Publication
(10) Pub. No.: US 2011/0251723 A1
(43) Pub. Date: Oct. 13, 2011

(54) Method for Improving the Simulation of Object Flows using Brake Classes

(76) Inventors: Wolfram Klein, Neubiberg (DE); Gerta Köster, Munchen (DE); Andreas Meister, Mering (DE)

(21) Appl. No.: 13/140,583

(22) PCT Filed: Dec. 16, 2009
(86) PCT No.: PCT/EP09/67255

§ 371 Date: Jun. 17, 2011

(30) Foreign Application Priority Data
Dec. 17, 2008 (DE) 10 2008 063 452.2

(51) Int. Cl. G06F 17/10; G05B 15/02

(52) U.S. Cl. 700/275; 703/2; 703/6

(57) ABSTRACT

A method for simulating object flows which move in an area, the method being based on cellular automata is improved in such a way that the simulation depicts the object flows as realistically as possible. It is further proposed that based on a desired speed of an object, the speed is lowered as the object density increases using a brake class table having a plurality of brake classes in such a way that a relationship between the object density and the object speed results according to a fundamental diagram. Thus, conventional methods for simulation of object flows are improved. The method is suitable in particular for flows of persons.

### CROSS-REFERENCE TO RELATED APPLICATIONS

This application is a U.S. National Stage Application of International Application No. PCT/EP2009/067255 filed Dec. 16, 2009, which designates the United States of America, and claims priority to DE Application No. 10 2008 063 452.2 filed Dec. 17, 2008. The contents of which are hereby incorporated by reference in their entirety.

### TECHNICAL FIELD

The present invention relates to a method for improving the simulation of object flows by means of brake classes.

### BACKGROUND

Wherever there are large numbers of objects or people, phenomena occur that are typical of masses. Some of these phenomena threaten the safety of life and limb, e.g. when panic breaks out at a mass event. Further phenomena require suitable control measures, in order to organize event sequences in a manner that is technically and economically efficient. Examples of this include “evacuation” of a site following a mass event, for example a football stadium and its surroundings, or the control of road traffic at peak traffic times.

A number of approaches are known from the prior art, in particular for the purpose of simulating flows of people and cars. However, the conventional approaches have deficiencies which restrict an accurate depiction of mass phenomena and hence the usability of simulation results.

Solutions are sought which overcome certain common deficiencies in a method that is described here, in order thus to achieve effective modeling and simulation of object flows, this forming a module of a command and control center, i.e. a control unit for object flows and in particular people flows.

When planning large buildings or mass transport means, people flow simulators are usually used in order to identify bottlenecks and conflict points, e.g. in corridors and stairwells, at the earliest possible planning phase and to dimension the infrastructure accordingly. A primary objective of conventional people flow simulators is the calculation of evacuation times in the context of extraordinary events, e.g. the outbreak of fire, in order that the verification of evacuation times as required by the legislative body can be provided.

An approach that is often selected for the purpose of people flow simulation uses methods based on “cellular state automata” [1]. In this context, an area such as a street is covered by a cellular grid. A hexagonal grid has been selected in FIG. 1, for example. Square cells are likewise customary. Each cell can assume various states such as e.g. full, and specifically with an obstacle, or occupied by a person, or empty. Such states are updated in real time via rule sets or automata. The following submodels and their interaction contain the key ideas behind these automata:
A destination model specifies how objects/people move to a destination.
An object movement model or people movement model specifies how objects/people behave relative to each other.
An obstacle model defines how objects/people move around obstacles.

An approach is now demonstrated which emulates known mechanisms from the physics of electronics. This is realized by means of potential fields in the mathematical formulation.

Destinations attract objects/people in the same way as a positive charge attracts electrons. The strength of the potential field is determined in the prior art [1] as a function of the Euclidean distance of the person/object from the destination. An example of this is given for greater comprehensibility:

The potential field of a destination point is derived from the coordinates of the destination z of the currently observed person x^{AP} scaled using a factor S. The symbol ∥ ∥ designates the Euclidean norm. Corresponding to a cone in a two-dimensional space, the scaling factor S determines the width of the opening of the destination potential. Formula I shows an example of a potential function for a destination point having a weighting factor S:

U(x^{AP})=S·∥z−x^{AP}∥ Formula (I)

Objects/people mutually repel each other in the same way as electrons repel each other. The strength of the potential field is determined in the conventional manner as a function of the Euclidean distance between the people/objects.

Obstacles repel objects/people in the same way as a negative charge repels electrons. The strength of the potential field is determined in the conventional manner as a function of the Euclidean distance of the person/object from the obstacle.

A method using cellular state automata has the following advantages. Simulation results can be obtained very quickly on a computer, even for very large numbers of people or objects. This presupposes a lean implementation. The results using cellular state automata are closer to reality than those from macroscopic simulations, for example. The model of the cellular state automata is very flexible, in order to depict many different scenarios. At the same time, the illustration of the full or empty cells offers an intuitively comprehensible visualization. In addition, simulators that are based on cellular state automata can easily be enhanced to become interactive simulators.

The method using cellular state automata according to the prior art has disadvantages. The theoretically very powerful approach using potential fields in accordance with the present prior art features a number of disadvantages which significantly restrict the practical use of simulation results. This concerns in particular the correct depiction of observed and measured mass and movement phenomena, without which any practical use of a simulator is limited. In particular, the following disadvantage is evident:

A disadvantage of the prior art is an incorrect depiction of the relationship between density and speed in the case of people flows. The speed of movement in a crowd depends on the density of the crowd. The denser the crowd, the slower the progress of the individual, even when the desired speed of an object would be high if the path was clear. The denser the crowd, the smaller the influence of individual desires to move. This phenomenon is represented in so-called fundamental diagrams. Fundamental diagrams can vary according to a situation, e.g. pedestrian zone, evacuation, age group, cultural background and so forth. A fundamental diagram shows a frequency distribution of object speeds as a function of the object density. Most widely used is the fundamental diagram according to Weidmann, as illustrated in FIG. 2. For simulators to be used effectively in practice, the behavior that is illustrated in the fundamental diagram must be reproduced not only in principle and qualitatively, but quantitatively in the simulation. It must be possible to adjust or calibrate the behavior to the correct fundamental diagram using parameters in each case. This is not possible in the method according to the prior art, as demonstrated by the experiment illustrated in FIG. 3. In this case, the simulated speeds are generally too high and cannot be calibrated.

### SUMMARY

According to various embodiments, a method for simulating object flows which move in an area, using cellular state automata, can be improved such that the simulation depicts the object flows as realistically as possible. In particular, it is intended to produce a correct depiction of the relationship between density and speed, in particular for people flows.

According to an embodiment, in a device for generating movements of particles in a spatial area of the device, said movements being captured by means of a first capturing entity, wherein the area is covered by a cellular grid and each cell can assume various states of occupancy and overall potential, said states being adjusted and updated over time by means of a computer entity and a control entity, wherein each cell is assigned a destination potential which specifies how particles are attracted by a destination, and an obstacle potential which specifies how particles are repelled by an obstacle, and wherein each particle is assigned a particle potential, wherein an overall potential in a cell is composed of the values of the destination potential and the obstacle potential in the cell and the particle potentials of particles which are in adjacent cells to the cell and are captured by means of the first capturing entity, and starting from a respective start cell, particles pass from one cell into an adjacent cell having a lowest overall potential in each case, and wherein starting from an average speed which is initially assigned to a particle, said speed is lowered using speed reductions as a function of increasing particle density by means of the computer entity and a brake class table that is stored in a storage entity and comprises a number of brake classes, such that a relationship between particle density and particle speed is produced in accordance with a fundamental diagram.

According to a further embodiment, the fundamental diagram can be a fundamental diagram for people flows according to Weidmann. According to a further embodiment, the average speed that is initially assigned to the particle can be an average speed with a Gaussian distribution. According to a further embodiment, use can be made of a specific number of different initially assigned average speeds and respectively associated brake class tables. According to a further embodiment, the particle density can be the number of further particles in cells, per overall surface of these cells, which are positioned around a particle in rings of the cellular grid. According to a further embodiment, the particle density can be the number of further particles in cells, per overall surface of these cells, which have a lower destination potential than the particle. According to a further embodiment, on the basis of a particle density, an index of the brake class associated with this particle density can be consulted and a corresponding speed reduction is added to the average speed that was initially assigned to the particle. According to a further embodiment, a cell variable can be selected in such a way that, for an initially assigned average particle speed, a discrete whole-number cell speed value is generated in cells covered per time step. According to a further embodiment, speed reductions can be in each case discrete whole-number cell speed values in cells covered per time step. According to a further embodiment, a speed reduction can be assigned to a brake class in each case. According to a further embodiment, real object movements can be captured by means of a second capturing entity for the purpose of initializing positions of the particles, start cells, destinations and particle speeds. According to a further embodiment, the device may comprise an analysis entity for analyzing the particle movements that are captured by means of the first capturing entity. According to a further embodiment, the analysis entity may generate control pulses to an operations control center. According to a further embodiment, the device may comprise the operations control center for controlling building elements. According to a further embodiment, building elements are doors, windows, information notices, loudspeakers, elevators, escalators and/or lights.

According to another embodiment, a method for generating particle flows, may comprise the steps:—providing a device comprising a spatial area that is covered by a cellular grid, wherein each cell assumes various states of occupancy and overall potential, these being adjusted by means of a control entity and a computer entity, wherein each cell is assigned a destination potential which specifies how particles are attracted by a destination, and an obstacle potential which specifies how particles are repelled by an obstacle, and wherein each particle is assigned a particle potential, wherein an overall potential in a cell is composed of the values of the destination potential and the obstacle potential in the cell and the particle potentials of particles which are in adjacent cells to the cell and are captured by means of the first capturing entity;—positioning particles at respective start cells, wherein the particles subsequently pass from one cell into an adjacent cell having a lowest overall potential in each case;—capturing the positions of the particles by means of the first capturing entity;—updating the overall potential states by means of the first capturing entity, the computer entity and the control entity, characterized in that starting from an average speed which is initially assigned to a particle, said speed is lowered using speed reductions as a function of increasing particle density by means of the computer entity and a brake class table that is stored in a storage entity and comprises a number of brake classes, such that a relationship between particle density and particle speed is produced in accordance with a fundamental diagram.

According to a further embodiment of the method, the fundamental diagram can be a fundamental diagram for people flows according to Weidmann. According to a further embodiment of the method, the average speed that is initially assigned to the particle can be an average speed with a Gaussian distribution. According to a further embodiment of the method, use can be made of a specific number of different initially assigned average speeds and respectively associated brake class tables. According to a further embodiment of the method, the particle density can be the number of further particles in cells, per overall surface of these cells, which are positioned around a particle in rings of the cellular grid. According to a further embodiment of the method, the particle density can be the number of further particles in cells, per overall surface of these cells, which have a lower destination potential than the particle. According to a further embodiment of the method, on the basis of a particle density, an index of the brake class associated with this particle density can be consulted and a corresponding speed reduction is added to the average speed that was initially assigned to the particle. According to a further embodiment of the method, a cell variable can be selected in such a way that, for an initially assigned average particle speed, a discrete whole-number cell speed value is generated in cells covered per time step. According to a further embodiment of the method, speed reductions can be in each case discrete whole-number cell speed values in cells covered per time step. According to a further embodiment of the method, a speed reduction can be assigned to a brake class in each case. According to a further embodiment of the method, real object movements can be captured by means of a second capturing entity for the purpose of initializing positions of the particles, start cells, destinations and particle speeds. According to a further embodiment of the method, an analysis entity can be provided for analyzing the particle movements that are captured by means of the first capturing entity. According to a further embodiment of the method, the analysis entity may generate control pulses to an operations control center. According to a further embodiment of the method, the operations control center for controlling building elements can be provided. According to a further embodiment of the method, building elements can be doors, windows, information notices, loudspeakers, elevators, escalators and/or lights.

According to yet another embodiment, a device as described above, or of a method as described above, can be used for simulating people flows, vehicle movements and/or animal movements and/or for controlling people flows, vehicle movements and/or animal movements by means of an operations control center.

### BRIEF DESCRIPTION OF THE DRAWINGS

The present invention is described in greater detail with reference to an exemplary embodiment and in connection with the figures, in which:

FIG. 1 shows illustrations for producing a grid network and determining an object density;

FIG. 2 shows a fundamental diagram according to Weidmann;

FIG. 3 shows density as a function of speed of movement using a conventional simulation for a crossover scenario;

FIG. 4 shows illustrations of linear and exponential potential field functions;

FIG. 5 shows density as a function of speed of movement using a simulation according to various embodiments for a crossover scenario;

FIG. 6 shows an exemplary embodiment of a device;

FIG. 7 shows an exemplary embodiment of a method.

### DETAILED DESCRIPTION

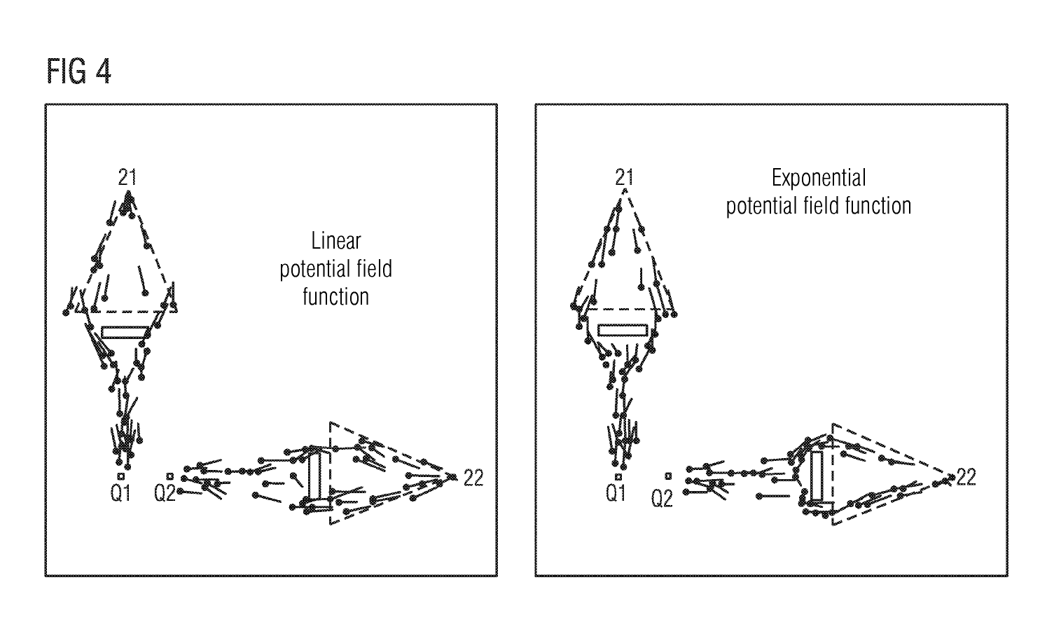

The functions of potentials as described in the application can also be referred to as potential field functions. For example, FIG. 4 illustrates a linear potential field function on the left-hand side and an exponential potential field function on the right-hand side.

Various embodiments address the problem of providing supplementary methods which are based on the prior art and overcome the common deficiencies cited above.

Various embodiments focus on a device and a method for generating flows of objects or particles. This device and this method are used generally for particle flows. Various embodiments relate to particle flows of any mobile particles. Such objects or particles can be metal balls, for example. The objects or particles can represent e.g. people, people on means of transport such as bicycles or motor vehicles, or similarly, animals.

Various embodiments are designed to provide a series of methodical improvements, each of which mitigates or overcomes one or more of the disadvantages of a conventional method. It is designed to produce a clearly improved overall behavior of object flows, i.e. an accurate depiction of actual behavior.

The various embodiments overcome the described deficiencies in the prior art. The simulation of object flows, in particular people flows, is made significantly more realistic by virtue of various embodiments, and the actual behavior of masses of objects or masses of people in various situations is depicted more effectively.

According to a first aspect, a device can be provided for generating movements of particles in a spatial area of the device, said movements being captured by means of a first capturing entity, wherein the area is covered by a cellular grid and each cell can assume various states of occupancy and overall potential, said states being adjusted and updated over time by means of a computer entity and a control entity, wherein each cell is assigned a destination potential which specifies how particles are attracted by a destination, and an obstacle potential which specifies how particles are repelled by an obstacle, and wherein each particle is assigned a particle potential, wherein an overall potential in a cell is composed of the values of the destination potential and the obstacle potential in the cell and the particle potentials of particles which are in adjacent cells to the cell and are captured by means of the first capturing entity, and wherein starting from a respective start cell, particles pass from one cell into an adjacent cell having a lowest overall potential in each case. Destination potential, object potential and obstacle potential can be determined e.g. by functions of the Euclidean distances of an object from a destination, of objects from each other, and of an object from an obstacle. According to the first aspect, starting from an average speed which is initially assigned to a particle, said speed is lowered using speed reductions as a function of increasing particle density by means of the computer entity and a brake class table that is stored in a storage entity and comprises a number of brake classes, such that a relationship between particle density and particle speed is produced in accordance with a fundamental diagram.

A capturing entity can be an optical capturing entity such as a camera, for example.

Occupancy states can be: occupied by or empty of a particle, obstacle, destination or source.

According to a second aspect, a method for generating particle flows can be provided and comprises the steps:—providing a device comprising a spatial area that is covered by a cellular grid, wherein each cell assumes various states of occupancy and overall potential, these being adjusted by means of a control entity and a computer entity, wherein each cell is assigned a destination potential which specifies how particles are attracted by a destination, and an obstacle potential which specifies how particles are repelled by an obstacle, and wherein each particle is assigned a particle potential, wherein an overall potential in a cell is composed of the values of the destination potential and the obstacle potential in the cell and the particle potentials of particles which are in adjacent cells to the cell and are captured by means of the first capturing entity;—positioning particles at respective start cells, wherein the particles subsequently pass from one cell into an adjacent cell having a lowest overall potential in each case;—capturing the positions of the particles by means of the first capturing entity;—updating the overall potential states by means of the first capturing entity, the computer entity and the control entity. According to the second aspect, starting from an average speed which is initially assigned to a particle, said speed is lowered using speed reductions as a function of increasing particle density by means of the computer entity and a brake class table that is stored in a storage entity and comprises a number of brake classes, such that a relationship between particle density and particle speed is produced in accordance with a fundamental diagram.

According to a third aspect, a device or a method according to various embodiments is used for simulating people flows, vehicle movements and/or animal movements and/or for controlling people flows, vehicle movements and/or animal movements by means of an operations control center.

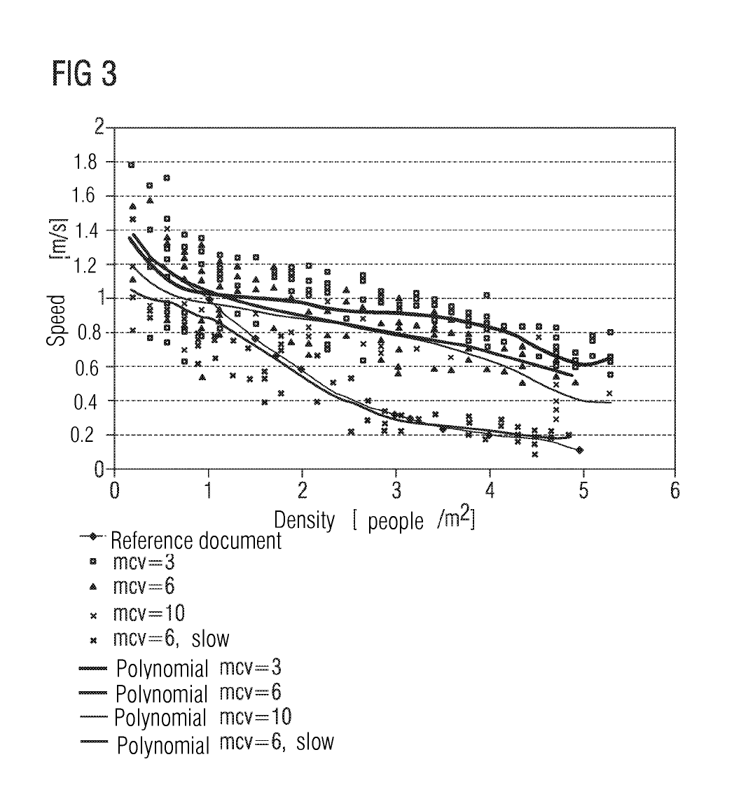

A comparison of conventional simulation models, in particular a conventional particle potential function or its speed behavior, with real data relating to people as described in the references, shows that the speed of the simulated people is clearly too high. Although a dependency between density and speed is established, the functional relationship of this dependency does not correspond exactly between reality and simulation. This is shown in FIG. 3, for example. A problem arises in the case of excessive speeds in dense crowds. This is solved by means of an approach for speed adaptation. The method according to various embodiments improves the speed behavior by introducing so-called brake classes. For improved behavior in congestion situations, the speed is now adapted relative to the density. The brake classes are used as an approach for this purpose.

The various embodiments offer the possibility of model calibration in terms of the relationship between density of the mass and speed of movement, and therefore a first possibility for adaptation to real data.

According to an embodiment, the fundamental diagram can be a fundamental diagram for people flows according to Weidmann. This is shown in FIG. 2. Other fundamental diagrams can be produced on the basis of experiments. For example, if real data is available from an airport containing people with flight baggage and large suitcases, it is very probable that this will produce a different relationship between density and speed than is produced according to Weidmann.

According to a further embodiment, the average speed which is initially assigned to the particles can be an average speed with Gaussian distribution. Each person usually has a desired speed at which said person would like to move. This speed was assigned to the person and provided initially, at the time said person was generated, from a Gaussian distribution using a predefined average speed.

According to a further embodiment, a specific number of different initially assigned average speeds and relevant associated brake class tables can be utilized.

According to a further embodiment, the particle density can be the number of further particles in cells, per overall surface of these cells, which are positioned around a particle in rings of the cellular grid.

According to a further embodiment, the particle density can be the number of further particles in cells, per overall surface of these cells, which have a lower destination potential than the particle.

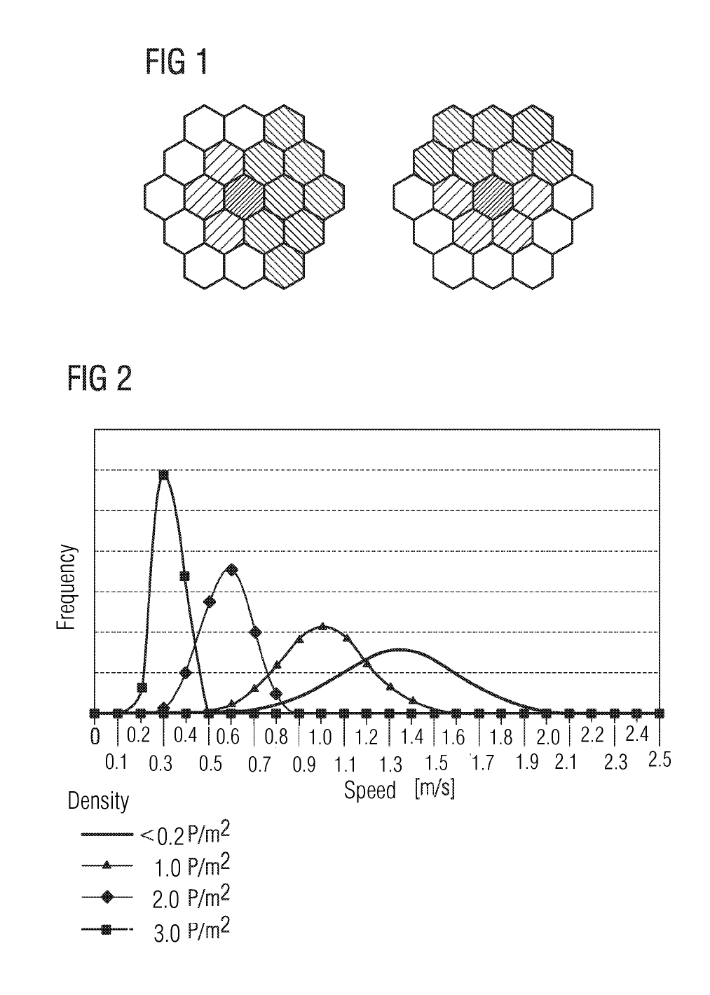

For a person in the simulator, for example, in the two inner rings of the grid around the person, those positions are selected (see in particular FIG. 1) which lie closer to the destination than the person and therefore have a lower destination potential. Since the grid has various geometric properties, the number of these observed cells also depends on the direction and the distance of the destination. The two illustrations in FIG. 1 show the differences in the number and nature of the observed cells. A people density in the observation field can be derived from this. The values relate to the observed area in a destination direction, and more specifically to the number of people in the observed area in a destination direction. With regard to the angle of view of the current person to the destination, i.e. the next possible cell positions of said person, FIG. 1 shows 8 possible cells on the left-hand side and 7 possible cells on the right-hand side. Other density specifications are also possible in principle. For example, two, three or four rings can be used. Likewise, all of the cells in the rings can be taken into account, and not just those in the destination direction.

According to a further embodiment, on the basis of a particle density, an index of a brake class belonging to this particle density can be consulted and a corresponding speed reduction can be added to the initially assigned average speed associated with the particle. Table 2 shows an example of a brake class table (see page 15).

According to a further embodiment, a cell variable can be selected in such a way that, for an initially assigned average particle speed, a discrete whole-number cell speed value is generated in cells covered per time step. An initially assigned average particle speed is that speed which a particle has in the event of a particle density in the region of 0.

In the model, particles or people move by covering a certain number of cells in a time step. The speeds are therefore discrete. Reference is made to average cell speed. The average cell speed is a whole-number value which is assigned to a specific real speed. For example, in Table 2 the real speed 1.34 m/s corresponds to exactly six cells which a particle or a person must cover per time step.

According to a further embodiment, speed reductions in each case can be discrete whole-number cell speed values in cells covered per time step. The brake classes are defined such that, by virtue of a reduction in the cell speed, the value of the sum of desired cell speed and reduction corresponds again to a specific discrete whole-number cell speed. This is shown in column 5 of Table 2.

According to a further embodiment, the brake classes can be defined in such a way that a speed reduction is assigned to a brake class in each case.

According to a further embodiment, real object movements can be captured by a second capturing entity for the purpose of initializing positions of the particles, start cells, destinations and particle speeds.

According to a further embodiment, an analysis entity can be provided for analyzing the particle movements that are captured by means of the first capturing entity.

According to a further embodiment, the analysis entity can generate control pulses to an operations control center.

According to a further embodiment, the operations control center can control building elements.

According to a further embodiment, building elements (15) can be doors, windows, information notices, loudspeakers, elevators, escalators and/or lights.

FIG. 1 shows an illustration for producing a grid network and for determining a particle density or object density. FIG. 1 shows a neighborhood of a person or a particle, for a horizontal direction of travel as shown in the left-hand side of FIG. 1, and for a vertical direction of travel as shown on the right-hand side of FIG. 1. The observed cells which are relevant for determining a particle density are shown in gray. The black field shows the cell containing the person or object for which the object density is to be determined. In the illustration on the left-hand side, the destination is situated horizontally to the right. On the right-hand side, the destination is situated vertically upwards. FIG. 1 shows the approach that is frequently selected for simulating people flows or object flows on the basis of cellular state automata. In this case, an area, for example, a street is covered by a cellular grid. In FIG. 1, a hexagonal grid has been selected by way of example. Square cells are also commonly used. Each cell can assume various states, such as full, occupied by an obstacle or a person, or empty. FIG. 1 shows how a particle density is determined for a relevant particle or person. For a person in the simulator, in the two inner rings of the grid around the person, those positions are selected which lie closer to the destination than the actual person, and therefore have a lower destination potential. Since the grid has diverse geometric properties, the number of these observed cells also depends on the direction and the distance to the destination. The two diagrams in FIG. 1 show the differences in the number and nature of the observed cells. A particle density or a people density in the observation field can be derived from this. The values relate to the observed area in a destination direction, and more specifically to the number of particles or people in the observed area in a destination direction. These are highlighted in gray. With regard to the angle of view of the current particle or the current person to the destination, i.e. the next possible cell positions of said particle or person, there are 8 possible cells on the left-hand side and 7 possible cells on the right-hand side according to FIG. 1. Other density specifications are also possible in principle. For example, two, three or four rings can be used. Likewise, all of the cells in the rings can be taken into account, and not just those in the destination direction.

FIG. 2 shows a fundamental diagram according to Weidmann. The illustration shows the dependency of the speed of movement on the density of a crowd of people. As the density increases, the average speed at which a Gaussian distribution is generated decreases. The northing axis designates the frequency of the speed. The easting axis designates the speed. According to various embodiments, it is theoretically possible to use any fundamental diagram which illustrates the speed of movement as a function of the density of the crowd and a corresponding situation. In other words, fundamental diagrams other than that according to Weidmann can be derived from experiments. For example, if real data is available from an airport containing people with flight baggage and large suitcases, it is very probable that this will produce a different relationship between density and speed than is produced according to Weidmann.

FIG. 3 shows density as a function of a speed of movement using a conventional simulation in the context of a crossover scenario. The lowest curve shows the reference values of the fundamental diagram according to Weidmann. The values that are simulated in a conventional way are uniformly too high, i.e. the simulated speeds are not sufficiently dependent on the density. In other words, comparison of a conventional simulation model, in particular the people potential function or its speed behavior, with real data relating to people as described in the references, for example according to Weidmann, shows that the speed of the simulated people is clearly too high. Although a dependency between density and speed is established, the functional relationship of this dependency does not correspond exactly between reality and simulation. This is shown in FIG. 3. A problem therefore arises when using a conventional simulation in the case of excessive speeds in dense crowds.

FIG. 4 shows an illustration of a linear potential field function and an exponential potential field function. In this case, the two illustrations according to FIG. 4 show different functions, e.g. of a respective flooding value of a function of a flooding algorithm for obstacles. The two illustrations therefore represent results for both a destination potential and for two different obstacle potentials in particular. According to FIG. 4, only the obstacle potential was changed from linear to exponential. The linear potential field function is shown on the left-hand side and the exponential potential field function is shown on the right-hand side. FIG. 4 shows a comparison of the repulsion of particles or people from an obstacle on the basis of an attraction of particles or people by a destination, for linear or exponential potential field functions. Each dot represents a position of a particle or a person, and each line represents the direction of movement. Identical triangles are inserted for the sake of clarity. An obstacle potential field can be filled with linearly decreasing values, e.g. from a second obstacle flooding algorithm. An obstacle potential field which is defined in this way can also be replaced by a different potential field, e.g. an exponentially decreasing potential field. This advantageously allows improved calibration relative to real data, firstly because the value and hence the strength of the repulsion or attraction can be varied, and secondly because at the same time the strength/speed of the decrease in the repulsion or attraction can be calibrated away from the obstacle. The effect of the calibration of the modeling can therefore be adapted to the real data. This effect is illustrated in FIG. 4.

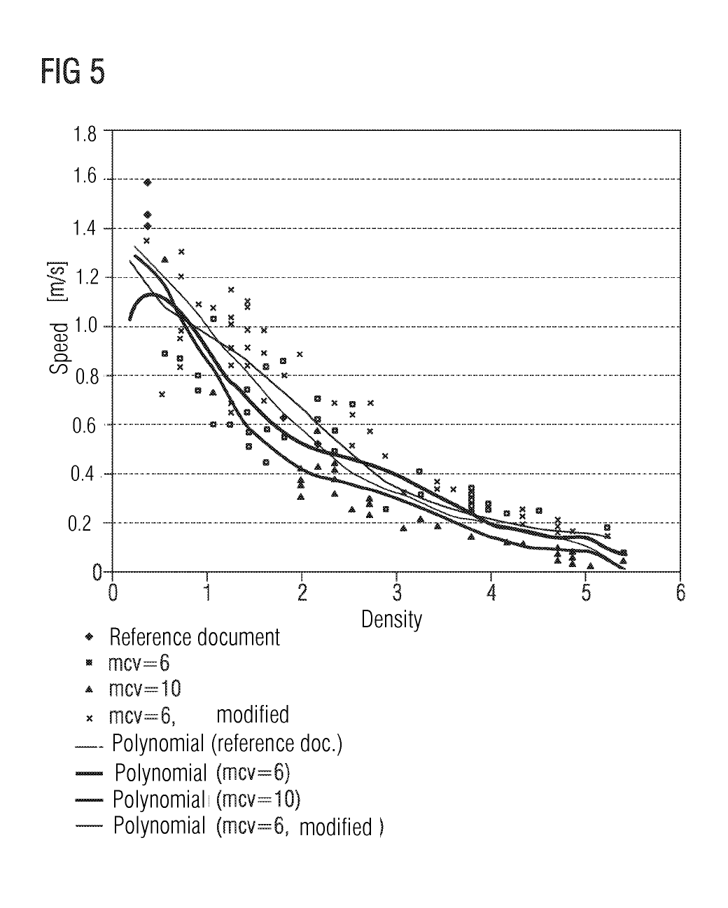

FIG. 5 shows density as a function of a speed of movement using a simulation according to various embodiments in the context of a crossover scenario. Such a result is effected by introducing a model of brake classes. FIG. 5 therefore shows density as a function of the speed of movement using the improved simulation method according to various embodiments using brake classes in the context of a crossover scenario. The uppermost curve at a density of <1 shows the reference values of the fundamental diagram according to Weidmann. The simulated values reproduce the observed values qualitatively and quantitatively after calibration.

A comparison of conventionally realized simulation models, comprising conventional particle potential functions of object potential functions and/or their speed behavior, with real data relating to people as described in the references, shows that the speed of the simulated people is clearly too high. Although a dependency between density and speed is established, the functional relationship of this dependency does not correspond exactly between reality and simulation. FIG. 3 shows a conventional simulation. A disadvantage is usually produced at excessive speeds in dense crowds. This is solved by an approach for speed adaptation. A method is presented below, wherein the speed behavior is improved by means of introducing so-called brake classes.

For improved behavior in congestion situations, the speed relative to the density is now adapted. As a result of this adaptation, the dependency of the speed on the density as per FIG. 3 changes to a change according to various embodiments as per FIG. 5. For improved behavior in congestion situations, the speed relative to the density is now adapted. For this purpose, so-called brake classes are used as an approach. For a people simulator, in the two inner rings of the grid around a particle or a person, those positions are selected which lie closer to the destination than the actual particle or person, and therefore have a lower destination potential. This is illustrated in FIG. 1. Since the grid has diverse geometric properties, the number of these observed cells also depends on the direction and the distance to the destination. The two illustrations in FIG. 1 show the differences in the number and nature of the observed cells. A particle density or a people density in the observation field can be derived from this. Such a particle density or people density is illustrated in column 2 of Table 1 below.

TABLE 1

| | Density in | |
|---|---|---|
| | people/m^{2am} | |
| | Example: | |
| | neighborhood with a | Speed as per |
| Number of people | maximum of 8 people | reference in m/s |
| 0 | 0.00 | 1.34 |
| 1 | 0.68 | 1.23 |
| 2 | 1.35 | 0.88 |
| 3 | 2.03 | 0.60 |
| 4 | 2.70 | 0.40 |
| 5 | 3.38 | 0.26 |
| 6 | 4.05 | 0.15 |
| 7 | 4.73 | 0.07 |
| 8 | 5.4 | 0.00 |

By way of example, column 3 of Table 1 shows the relevant values of the fundamental diagram according to Weidmann, i.e. the speed values collected experimentally for the density.

The values relate to the observed area in the destination area, specifically the number of particles or people in the observed area in a destination direction. This is represented in column 1 of Table 1. With regard to the angle of view of the current particle or the current person to the destination, i.e. with regard to the next possible cell positions of said particle or person, there are 8 possible cells in the left-hand illustration and 7 possible cells in the right-hand illustration of FIG. 1. Table 1 shows a relationship between density in angle of view and speed as per reference, this corresponding to a desired speed or an initially assigned average speed.

Various brake classes for this relationship between density and speed are now defined in a second table below:

TABLE 2

| | | Desired speed in | Cell speed | Cell speed |
|---|---|---|---|---|
| | | m/s | using the | reduction |
| | Number | (corresponding | example with | in |
| Brake | of | to density as | average cell | comparison |
| class | people | per reference) | speed mcv = 6 | with mcv = 6 |
| 0 | 0-1 | 1.34 | 6 | 0 |
| 1 | 2 | 0.88 | 4 | 2 |
| 2 | 3 | 0.60 | 3 | 3 |
| 3 | 4 | 0.40 | 2 | 4 |
| 4 | 5 | 0.26 | 1 | 5 |
| 5 | 6 | 0.15 | 1 | 5 |
| 6 | >=7 | 0.07 | 1 | 5 |

Columns 2 and 3 in Table 2 correspond to columns 1 and 3 in Table 1.

Table 2 shows a mapping of density and desired fundamental diagram speed (column 3) to brake classes and speed reduction for particles or people having a desired average cell speed of 6 cells per time step. In this second table, various brake classes are now defined for this relationship between density and speed. The fundamental diagram speed is a speed that is specified in the reference and corresponds to a predefined density. An example of a fundamental diagram is the fundamental diagram according to Weidmann as per FIG. 2. Other fundamental diagrams can also be used. A fundamental diagram speed is designated speed as per reference in Table 1. The number of brake classes in Table 2 is selected such that it delivers good results for a fundamental diagram according to Weidmann.

In the model, particles or people move by covering a certain number of cells in a time step. Such speeds are therefore discrete. In the conventional model, desired or initially assigned average cell speeds are assumed for each particle or person, wherein said speeds are too high in comparison with the real values. This respectively desired or initially assigned average cell speed of a particle or a person is a whole-number value which is assigned to a specific real speed. For example, the real speed 1.34 m/s in Table 2 corresponds exactly to 6 cells which a particle or a person must cover per time step.

The brake classes are defined in such a way that, by means of a reduction in this desired or initially assigned average cell speed, the value of the sum of desired or initially assigned average cell speed and reduction corresponds to a specific discrete cell speed again. This is shown in columns 4 and 5 of Table 2.

Now particles or people no longer move at their desired or initially assigned average cell speed of the particle, but at the speed which is produced from the sum of the desired or initially assigned average cell speed of the particle and a reduction. This means that the particles or people are no longer slowed down only if there are no free neighboring cells available with a suitable potential value, but they are also slowed down depending on the number of neighbors they have in a destination direction.

By virtue of the brake classes, it is possible to influence the excessive speed behavior. The desired average cell speed of a particle or a person can be adapted to a fundamental diagram in this way. As a result of the observed angle of view, particles or people now slow down more if they encounter an increased particle density or people density in the vicinity of a group. As shown by the results in FIG. 3 and FIG. 5, this results in a clearly improved speed behavior, even in the case of higher densities.

In summary, each particle or person previously had one desired or initially assigned cell speed, at which said particle or person was to move. This cell speed was notified to the particle or person at the time of generation from a Gaussian distribution by means of a predefined desired average cell speed (mcv) that was assigned initially. According to various embodiments, the density in the angle of view of the particle or person is now calculated in accordance with FIG. 1. From this, an index of the brake class associated with this density is consulted, and the corresponding speed reduction is added to the initially assigned average cell speed belonging to the particle or the person, such that said particle or person then moves at a cell speed which is less than the desired average cell speed that was initially assigned to a particle or a person.

The model of the brake classes can also be generalized. Column 4 in Table 2 was selected in such a way that the cell speed of the particle or person when appropriately converted into m/s corresponds to the fundamental diagram according to Weidmann, i.e. to column 3 in Table 2, starting from a predefined desired average cell speed which is initially assigned to the particle or person, specifically mcv=6 in this case. The following generalizations can be made:

Table 2 can also be applied to particles or people having a different desired and initially assigned average cell speed than mcv=6 as in this case. Provision is made for calculating the cell speeds that are suitable in each case for a brake class, wherein said cell speeds correspond to column 4, and the associated reductions corresponding to column 5. In this case, provision is made for adapting the cell speeds in column 4 in the same way as the desired speeds, for example according to Weidmann, corresponding to column 3.

A decrease/increase in the number of brake classes, which comprises seven brake classes as per Table 2, is likewise possible and was tested. For a different fundamental diagram than that of Weidmann, a higher number of brake classes might be required. The number of seven brake classes selected here is based on a good balance between a discretization (or number of brake classes) that is too approximate or too specific.

The values cited here for the brake class model were selected in accordance with the fundamental diagram according to Weidmann. Other fundamental diagrams can be produced as a result of experiments. For example, if real data is available from an airport containing people with flight baggage and large suitcases, it is very probable that this will produce a different relationship between density and speed than is produced according to Weidmann. In so far as this relationship is clear, the present brake class model can be adapted correspondingly. The following changes can also be applied:
Number of brake classes;
Number of average cell speeds;
Assignment of average cell speeds to actual speeds;
Values of the reduction in the cell speed.

The values of the reduction as specified in column 5 of Table 2 were selected such that their addition to the predefined desired and initially assigned average cell speed of the particle or person corresponds to the values in column 4 of Table 2 and hence to the Weidmann values. However, if simulative results show that the calculated speeds do not correspond to the real data nevertheless, i.e. the objects or people are too fast or too slow, the reduction parameters can also be adapted correspondingly.

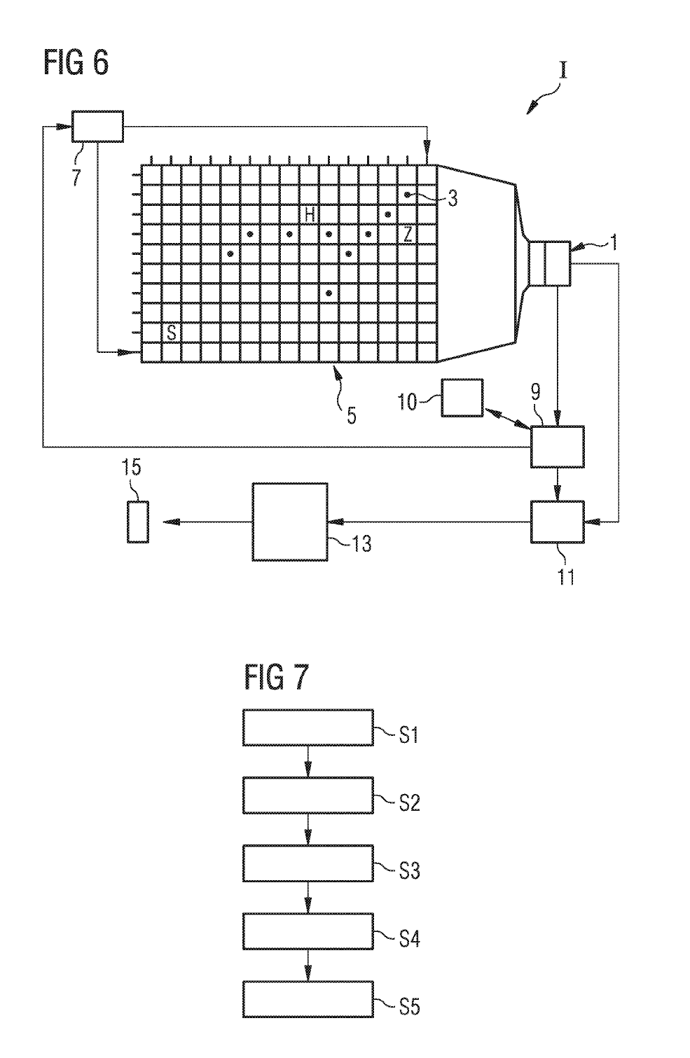

FIG. 6 shows an exemplary embodiment of a device.

The device I generates a movement of particles 3 which can be metal balls, for example.

The device I features a cellular grid 5 on a spatial area. Each cell is assigned an overall potential which can change relative to time. Particles 3 (e.g. metal beads) are initially positioned on the cellular grid 5. A number can be n=50 beads. A control entity 7 can assign overall potential values, which can change relative to time, to the cells. Each cell can be assigned an electromagnet, for example, whose magnetic strength can be adjusted by means of the control entity 7. The control entity 7 can adjust a relevant potential by means of a current through an electromagnet. At a start time Ts, the potentials are activated by means of the control entity 7, the beads move, starting from a respective start cell S, past other beads and obstacles H in each case, to the destination Z. At an end time Te, all beads can have reached their destinations Z. A first capturing entity 1, e.g. a camera, can be used for visualizing and/or capturing the movement of the beads. The information—this can be the movement directions of particles 3—from the first capturing entity 1 can be used in a computer entity 9 for the purpose of calculating relevant particle potentials. The information from the first capturing entity 1 can likewise be evaluated in an analysis entity 11. A particle density in the cellular grid 5 can be captured and analyzed thus, for example. The analysis entity 11 can output control signals to an operations control center 13 for controlling building elements 15, e.g. doors or information notices. The device I can likewise be emulated by a computer, for example. The device I is suitable in particular for simulation of people flows in buildings, for example. The model of the device I can be transferred to a computer by means of a corresponding model according to various embodiments. In other words, the device I can likewise be emulated by a computer. Such an embodiment is also included in the scope of protection of this application.

FIG. 7 shows an exemplary embodiment of a method.

In a step S1, provision is made for a device comprising a spatial area that is covered by a cellular grid 5, wherein each cell assumes various states of occupancy and overall potential, these being adjusted by means of a control entity 7 and a computer entity 9, wherein each cell is assigned a destination potential which specifies how particles 3 are attracted by a destination Z, and an obstacle potential which specifies how particles 3 are repelled by an obstacle H, and wherein each particle 3 is assigned a particle potential, wherein an overall potential in a cell is composed of the values of the destination potential and of the obstacle potential in the cell and the particle potentials of particles 3 in neighboring cells of the cell, said particles 3 being captured by means of a first capturing entity 1. In a step S2, provision is made for positioning particles 3 at relevant start cells S, wherein the particles 3 then pass from one cell into an adjacent cell having a lowest overall potential in each case.

In a step S3, provision is made for capturing the positions of the particles 3 by means of the first capturing entity 1. In a step S4, provision is made for updating the overall potential states by means of the first capturing entity 1, the computer entity 9 and the control entity 7. In a step S5, starting from an average speed that is initially assigned to a particle 3, said speed is lowered using speed reductions as a function of increasing particle density by means of the computer entity 9 and a brake class table which is stored in a storage entity 10 and features a number of brake classes, such that a relationship between particle density and particle speed is produced in accordance with a fundamental diagram. The method can be executed by means of software, for example.

### DOCUMENT REFERENCES

[1] C. Kinkeldey. Fuβgängersimulation auf der Basis zellularer Automaten. Kapitel 4. Studienarbeit Universität Hannover, 2003.

What is claimed is:

1. A device for generating movements of particles in a spatial area of the device, said movements being captured by means of a first capturing entity, wherein the area is covered by a cellular grid and each cell can assume various states of occupancy and overall potential, said states being adjusted and updated over time by means of a computer entity and a control entity, wherein each cell is assigned a destination potential which specifies how particles are attracted by a destination, and an obstacle potential which specifies how particles are repelled by an obstacle, and wherein each particle is assigned a particle potential, wherein an overall potential in a cell is composed of the values of the destination potential and the obstacle potential in the cell and the particle potentials of particles which are in adjacent cells to the cell and are captured by means of the first capturing entity, and starting from a respective start cell, particles pass from one cell into an adjacent cell having a lowest overall potential in each case, and wherein
starting from an average speed which is initially assigned to a particle, said speed is lowered using speed reductions as a function of increasing particle density by means of the computer entity and a brake class table that is stored in a storage entity and comprises a number of brake classes, such that a relationship between particle density and particle speed is produced in accordance with a fundamental diagram.

2. The device according to claim 1, wherein the fundamental diagram is a fundamental diagram for people flows according to Weidmann.

3. The device according to claim 1, wherein the average speed that is initially assigned to the particle is an average speed with a Gaussian distribution.

4. The device according to claim 1, wherein use is made of a specific number of different initially assigned average speeds and respectively associated brake class tables.

5. The device according to claim 1, wherein the particle density is the number of further particles in cells, per overall surface of these cells, which are positioned around a particle in rings of the cellular grid.

6. The device according to claim 1, wherein the particle density is the number of further particles in cells, per overall surface of these cells, which have a lower destination potential than the particle.

7. The device according to claim 1, wherein on the basis of a particle density, an index of the brake class associated with this particle density is consulted and a corresponding speed reduction is added to the average speed that was initially assigned to the particle.

8. The device according to claim 1, wherein a cell variable is selected in such a way that, for an initially assigned average particle speed, a discrete whole-number cell speed value is generated in cells covered per time step.

9. The device according to claim 1, wherein speed reductions are in each case discrete whole-number cell speed values in cells covered per time step.

10. The device according to claim 1, wherein a speed reduction is assigned to a brake class in each case.

11. The device according to claim 1, wherein real object movements are captured by means of a second capturing entity for the purpose of initializing positions of the particles, start cells, destinations and particle speeds.

12. The device according to claim 1, comprising an analysis entity for analyzing the particle movements that are captured by means of the first capturing entity.

13. The device according to claim 11, comprising an analysis entity for analyzing the particle movements that are captured by means of the first capturing entity, wherein the analysis entity generates control pulses to an operations control center.

14. The device according to claim 13, comprising the operations control center for controlling building elements.

15. The device according to claim 14, wherein building elements are at least one of doors, windows, information notices, loudspeakers, elevators, escalators and lights.

16. A method for generating particle flows, comprising the steps
providing a device comprising a spatial area that is covered by a cellular grid, wherein each cell assumes various states of occupancy and overall potential, these being adjusted by means of a control entity and a computer entity, wherein each cell is assigned a destination potential which specifies how particles are attracted by a destination, and an obstacle potential which specifies how particles are repelled by an obstacle, and wherein each particle is assigned a particle potential, wherein an overall potential in a cell is composed of the values of the destination potential and the obstacle potential in the cell and the particle potentials of particles which are in adjacent cells to the cell and are captured by means of the first capturing entity;
positioning particles at respective start cells, wherein the particles subsequently pass from one cell into an adjacent cell having a lowest overall potential in each case;
capturing the positions of the particles by means of the first capturing entity;
updating the overall potential states by means of the first capturing entity the computer entity and the control entity, characterized in that starting from an average speed which is initially assigned to a particle, said speed is lowered using speed reductions as a function of increasing particle density by means of the computer entity and a brake class table that is stored in a storage entity and comprises a number of brake classes, such that a relationship between particle density and particle speed is produced in accordance with a fundamental diagram.

17. The method according to claim 16, wherein the fundamental diagram is a fundamental diagram for people flows according to Weidmann.

18. The method according to claim 16, wherein the average speed that is initially assigned to the particle is an average speed with a Gaussian distribution.

19. The method according to claim 16, wherein use is made of a specific number of different initially assigned average speeds and respectively associated brake class tables.

20. The method according to claim 16, wherein the particle density is the number of further particles in cells, per overall surface of these cells, which are positioned around a particle in rings of the cellular grid.

21. The method according to claim 16, wherein the particle density is the number of further particles in cells, per overall surface of these cells, which have a lower destination potential than the particle.

22. The method according to claim 16, wherein on the basis of a particle density, an index of the brake class associated with this particle density is consulted and a corresponding speed reduction is added to the average speed that was initially assigned to the particle.

23. The method according to claim 16, wherein a cell variable is selected in such a way that, for an initially assigned average particle speed, a discrete whole-number cell speed value is generated in cells covered per time step.

24. The method according to claim 16, wherein speed reductions are in each case discrete whole-number cell speed values in cells covered per time step.

25. The method according to claim 16, wherein a speed reduction is assigned to a brake class in each case.

26. The method according to claim 16, wherein real object movements are captured by means of a second capturing entity for the purpose of initializing positions of the particles, start cells, destinations and particle speeds.

27. The method according to claim 16, comprising analyzing by an analysis entity the particle movements that are captured by means of the first capturing entity.

28. The method according to claim 26, comprising analyzing by an analysis entity the particle movements that are captured by means of the first capturing entity, wherein the analysis entity generates control pulses to an operations control center.

29. The method according to claim 28, comprising controlling building elements by the operations control center.

30. The method according to claim 29, wherein building elements are at least one of doors, windows, information notices, loudspeakers, elevators, escalators and lights.

31. A method according to claim 16, using the method for at least one of simulating at least one of people flows, vehicle movements, animal movements and for controlling at least one of people flows, vehicle movements and animal movements by means of an operations control center.

32. The method according to claim 31, wherein the method uses a device for generating movements of particles in a spatial area of the device, said movements being captured by means of a first capturing entity, wherein the area is covered by a cellular grid and each cell can assume various states of occupancy and overall potential, said states being adjusted and updated over time by means of a computer entity and a control entity, wherein each cell is assigned a destination potential which specifies how particles are attracted by a destination, and an obstacle potential which specifies how particles are repelled by an obstacle, and wherein each particle is assigned a particle potential, wherein an overall potential in a cell is composed of the values of the destination potential and the obstacle potential in the cell and the particle potentials of particles which are in adjacent cells to the cell and are captured by means of the first capturing entity, and starting from a respective start cell, particles pass from one cell into an adjacent cell having a lowest overall potential in each case, and wherein
starting from an average speed which is initially assigned to a particle, said speed is lowered using speed reductions as a function of increasing particle density by means of the computer entity and a brake class table that is stored in a storage entity and comprises a number of brake classes, such that a relationship between particle density and particle speed is produced in accordance with a fundamental diagram.
